(19) United States
(12) Patent Application Publication
(10) Pub. No.: US 2015/0329759 A1
(43) Pub. Date: Nov. 19, 2015

(54) HEATING MEDIUM COMPOSITION

(71) Applicant: JX NIPPON OIL & ENERGY CORPORATION, Tokyo (JP)

(72) Inventors: Takahiro KAWAGUCHI, Tokyo (JP); Tsutomu TAKASHIMA, Tokyo (JP); Nobuhiro KIMURA, Tokyo (JP)

(73) Assignee: JX NIPPON OIL & ENERGY CORPORATION, Chiyoda-ku, Tokyo (JP)

(21) Appl. No.: 14/655,194

(22) PCT Filed: Dec. 2, 2013
(86) PCT No.: PCT/JP2013/082377

§ 371 Date: Jun. 24, 2015

(30) Foreign Application Priority Data
Dec. 27, 2012 (JP) 2012-286062

(51) Int. Cl. C09K 5/08

(52) U.S. Cl. CPC C09K 5/08

(57) ABSTRACT

A heating medium composition includes biphenyl (A), diphenylene oxide (B), and at least one or more aromatic compounds (C) selected from six components of naphthalene, phenanthrene, anthracene, o-triphenyl, m-triphenyl, and p-triphenyl, wherein the biphenyl (A) is contained in a ratio of 15 to 50% by mass, the diphenylene oxide (B) is contained in a ratio of 10 to 40% by mass, the aromatic compounds (C) is contained in a ratio of 20 to 75% by mass, and diphenyl ether is not contained.

### FIELD

The present invention relates to a heating medium composition.

### BACKGROUND

A heating medium is widely used for heat removal in high-temperature exothermic reactions, heat reservoirs, and solar thermal power generation, and it is desired that there is stability in a wide temperature range from room temperature to higher temperatures. As the heating medium, disclosed conventionally is a heating medium composition containing an aromatic hydrocarbon-based heating medium composition, for example, biphenyl and diphenyl ether (see Patent Literature 1, for example).

As a heating medium excellent in high-temperature stability, disclosed is a composition in which diphenylene oxide is added to diphenyl ether (see Patent Literature 2, for example). Patent Literature 2 discloses that the stabilization effect of the diphenylene oxide can be applied to a eutectic mixture in which diphenyl, naphthalene, or the like is added to diphenyl ether.

Disclosed further is that a heating medium including a mixture of aryl compounds having 2 to 5 phenyl groups, for example, a four-component mixture of biphenyl, diphenyl ether, o-terphenyl, m-terphenyl, or the like is excellent in pump conveyability at low temperatures owing to freezing point depression (see Patent Literature 3, for example). Disclosed also is a heating medium composition containing diphenyl ether, benzophenone, and at least one component selected from the group consisting of dibenzofuran and naphthalene in a predetermined ratio can lighten maintenance, operation, and the like owing to freezing point depression (see Patent Literature 4, for example).

Disclosed further is that a heating medium composition including biphenyl, diphenyl ether, and diphenylene oxide is excellent in heat resistance and is easy to handle owing to freezing point depression (see Patent Literature 5, for example). Patent Literature 5 discloses that the heating medium composition may contain phenanthrene and methylnaphthalene in a small amount.

### CITATION LIST

### Patent Literature

Patent Literature 1: U.S. Pat. No. 1,882,809

Patent Literature 2: U.S. Pat. No. 1,874,256

Patent Literature 3: United States Patent No. H1393

Patent Literature 4: Japanese Patent Application Laid-open No. 01-261490

Patent Literature 5: Japanese Patent Application Laid-open No. 05-009465

### SUMMARY

### Technical Problem

In recent years, for the purpose of improving power generation efficiency for use in solar thermal power generation or the like, there are increasing development needs of a heat transfer oil usable in a higher-temperature range than conventional use temperatures. Although the heating medium compositions with aromatic compounds as a main component disclosed in Patent Literature 1 to 5 exhibit sufficient heat resistance at less than 400° C., they are not intended to be used at temperatures exceeding 400° C. In fact, when they are used at nearly 400° C., because of their insufficient heat stability, the use as the heating medium composition was difficult at a higher temperature range.

The present invention has been achieved in view of the above circumstances, and an object thereof is to provide a heating medium composition excellent in heat resistance.

### Solution to Problem

In view of the fact that continuous use of a heating medium composition at nearly 400° C. would cause the occurrence of decomposed phenol as well as the deterioration of components in the heating medium composition to induce metallic corrosion and limit stable long-term use of the heating medium composition, the inventors of the present invention have found that the main cause of the occurrence of decomposed phenol is diphenyl ether blended in the heating medium composition. The inventors have also found that a composition of biphenyl and diphenylene oxide blended with specific aromatic compounds in a predetermined ratio increases heat resistance and tends not to produce decomposed phenol, thereby achieving the present invention.

That is, a heating medium composition according to the present invention includes at least biphenyl (A) and diphenylene oxide (B), and further includes at least one or more aromatic compounds (C) selected from six components of naphthalene, phenanthrene, anthracene, o-triphenyl, m-triphenyl, and p-triphenyl, wherein the biphenyl (A) is contained in a ratio of 15 to 50% by mass, the diphenylene oxide (B) is contained in a ratio of 10 to 40% by mass, the aromatic compounds (C) is contained in a ratio of 20 to 75% by mass, and diphenyl ether is not contained.

Moreover, in the above-described heating medium composition according to the present invention, the biphenyl (A) is contained in a ratio of 15 to 40% by mass, the diphenylene oxide (B) is contained in a ratio of 10 to 40% by mass, and the aromatic compounds (C) is contained in a ratio of 20 to 75% by mass.

Moreover, in the above-described heating medium composition according to the present invention, the biphenyl (A) is contained in a ratio of 20 to 40% by mass, the diphenylene oxide (B) is contained in a ratio of 10 to 40% by mass, and an aromatic compound (C) selected from naphthalene and/or phenanthrene is contained in a ratio of 20 to 70% by mass.

Moreover, in the above-described invention, the heating medium composition according to the present invention is used in solar thermal power generation

### Advantageous Effects of Invention

The heating medium composition according to the present invention can be used continuously for the long term and is less likely to corrode equipment because it does not lose heat stability at higher temperatures of 400° C. or more or produce decomposed phenol. Thus, exhibiting the highest heat-resistant temperature as an organic heating medium, the heating medium composition according to the present invention can be suitably used for heat removal in high-temperature exothermic reactions, heat reservoirs, and solar thermal power generation heating media, or the like.

### DESCRIPTION OF EMBODIMENTS

Described below in detail is a preferred embodiment according to the present invention. The present invention is not limited by the embodiment described below.

The heating medium composition according to the present invention is a heating medium composition containing at least biphenyl (A) and diphenylene oxide (B), further containing at least one or more aromatic compounds (C) selected from six components of naphthalene, phenanthrene, anthracene, o-triphenyl, m-triphenyl, and p-triphenyl, and not containing diphenyl ether.

Among the ingredients of the heating medium composition according to the present invention, diphenylene oxide (B) and naphthalene, phenanthrene, and anthracene, as aromatic compounds (C) are contained in coal tar or the like, and their melting points are as high as 83° C., 82° C., 100° C., and 218° C., respectively, and they are solids at room temperature. Biphenyl (A) and triphenyl as one of aromatic compounds (C) can be obtained by reacting benzene with benzene. Triphenyl includes three isomers, namely, o-triphenyl, m-triphenyl, and p-triphenyl, which are all solids at room temperature (m.p. 56° C., 84° C., and 212° C., respectively) as is the case with biphenyl (m.p. 69° C.) and are all inappropriate as a heating medium in isolation.

The inventors of the present invention have found that a composition containing at least one or more aromatic compounds (C) selected from six components of naphthalene, phenanthrene, anthracene, o-triphenyl, m-triphenyl, and p-triphenyl in biphenyl (A) and diphenylene oxide (B) and not containing diphenyl ether has the freezing point depressed to allow use in a system and this reduces the production of corrosive decomposition products even at high temperatures, for example, nearly 400° C.

The heating medium composition according to the present invention contains biphenyl (A) in an amount of 15 to 50% by mass, preferably 20 to 45% by mass, and more preferably 25 to 40% by mass. When the content of biphenyl (A) is less than 15% by mass, the content ratios of the other components increase, resulting in a likelihood of its solidifying. When the content exceeds 50% by mass, the content ratio of biphenyl increases, resulting in a likelihood of its solidifying similarly.

The heating medium composition according to the present invention contains diphenylene oxide (B) in an amount of 10 to 40% by mass, preferably 10 to 35% by mass, and more preferably 15 to 30% by mass. When the content of diphenylene oxide (B) is less than 10% by mass, the content ratios of the other components increase, resulting in a likelihood of its solidifying. When the content exceeds 40% by mass, the content of diphenylene oxide increases, resulting in a likelihood of its solidifying similarly.

The heating medium composition according to the present invention contains at least one or more aromatic compounds (C) selected from six components of naphthalene, phenanthrene, anthracene, o-triphenyl, m-triphenyl, and p-triphenyl in an amount of 20 to 75% by mass, preferably 20 to 60% by mass. When the content of at least one or more aromatic compounds (C) selected from six components of naphthalene, phenanthrene, anthracene, o-triphenyl, m-triphenyl, and p-triphenyl is less than 20% by mass, the content ratios of other components increase, resulting in a likelihood of its solidifying. When the content exceeds 75% by mass, the content ratios of the aromatic compounds (C) increase, resulting in a likelihood of its solidifying similarly.

The heating medium composition according to the present invention contains naphthalene and/or phenanthrene as the aromatic compounds (C) in an amount of 20 to 60% by mass, preferably 20 to 55% by mass. When the content of naphthalene and/or phenanthrene as the aromatic compounds (C) is less than 20% by mass, the content ratios of the other components increase, resulting in a likelihood of its solidifying. When the content exceeds 60% by mass, the content ratio of naphthalene and/or phenanthrene increases, resulting in a likelihood of its solidifying similarly.

The heating medium composition according to the present invention does not contain diphenyl ether. In the present specification, not containing diphenyl ether means that the content of diphenyl ether within the heating medium composition according to the present invention is 5% by mass or less. It is preferable that the content of diphenyl ether within the heating medium composition is substantially zero. This is because when the content of diphenyl ether exceeds 5% by mass, the production amount of decomposed phenol tends to increase.

The total content of biphenyl (A), diphenylene oxide (B) and at least one or more aromatic compounds (C) selected from six components of naphthalene, phenanthrene, anthracene, o-triphenyl, m-triphenyl, and p-triphenyl is 80.0 to 99.9% by mass, preferably 90 to 99.9% by mass, and more preferably 95 to 99.9% by mass. When the total content is 80.0% by mass or less, the freezing point of the composition may rise, making it hard to handle, or heat resistance may decreases.

In the heating medium composition according to the present invention, for which the manufacturing method is not limited in particular, biphenyl and triphenyl are in general manufactured with benzene as a raw material through a palladium catalyst. Quarterphenyl, polyphenyl, and the like, which are by-products of biphenyl and triphenyl, may be contained in a trace amount in the manufacturing of biphenyl and triphenyl with benzene. Diphenylene oxide, naphthalene, phenanthrene, and anthracene are contained in coal tar or the like and can be obtained by distillation. Diphenylene oxide, naphthalene, phenanthrene, and anthracene may contain methylnaphthalene, dimethylnaphthalene, fluorene, methylphenanthrene, dibenzothiophene, acenaphthene, carbazole, phenyl dibenzofuran, or the like in a trace amount.

The heating medium composition according to the present invention can be used continuously without losing thermal stability at high temperatures of 400° C. or more and without producing decomposed phenol. The heat resistance of the heating medium composition can be evaluated by a thermal stability test at 430° C. for example. In the thermal stability test of the heating medium composition, the heating medium composition is put into a sealable container, the container is filled with nitrogen, the pressure in the container is adjusted to be 2 MPa (room temperature), and then the container containing the heating medium composition is held at 430° C. for 96 hours. The heat resistance of the heating medium composition is evaluated based on the decomposition ratio of the heating medium composition, the amount of produced decomposed phenol, and a pressure rise in the container after the test.

In the heating medium composition according to the present invention, the decomposition ratio in the thermal stability test is preferably 5.0% or less. The decomposition ratio of the heating medium composition can be measured by gas chromatography mass analysis. The ratio of a liquid component produced after the thermal stability test can be evaluated through the decomposition ratio measured by the following method. The following lists example analysis conditions.

Column: J&W DB-1 (30 m×0.25 mm dia.)
Carrier gas: helium
Injection volume: 0.2 μL

The decomposition ratio was determined by the following formula:

The decomposition ratio(%)=(the sum total of the peak areas that occurred after the test)/(the sum total of all peak areas)×100

The produced amount of decomposed phenol is preferably 0.20% or less. The amount of decomposed phenol was determined by the following formula:

The amount of decomposed phenol(%)=(the peak area of decomposed phenol that occurred after the test)/(the sum total of all peak areas)×100

In the heating medium composition according to the present invention, a pressure rise in the container after the thermal stability test is preferably 0.1 MPa or less. The pressure rise is a difference value between the pressure of the container cooled to room temperature after the test and the pressure before the test. Through the pressure rise, the ratio of a gas component decomposed and produced after the thermal stability test can be evaluated.

It is preferable that the melting point of the heating medium composition according to the present invention is preferably 30° C. or less, more preferably 25° C. or less. The melting point exceeding 25° C., which is preferably 25° C. or less, can still be used without problems when used in combination with an auxiliary thermal insulating system such as a heat storage tank.

Exhibiting the highest heat-resistant temperature as an organic heating medium, the heating medium composition according to the present invention is useful for heating media for heat removal in high-temperature reactions, heat reservoirs, and solar thermal power generation, for example, concentrating solar thermal power generation. The heating medium composition according to the present invention can be used as, for example, a heating medium for parabolic trough solar thermal power generation, which, using semi-cylindrical concentrating mirrors, concentrates solar light onto a pipe placed in front of the mirrors to heat the heating medium flowing through the pipe, thereby producing steam through the heated heating medium to generate power. It can also be used for tower type solar thermal power generation, which concentrates light onto a solar energy collector provided in a tower installed at the central position by concentrating solar light using plane mirrors and generates power through heat thus generated. The boiling point being about 220 to 300° C., the heating medium composition according to the present invention may be used under an extra pressure when it is used at high temperatures of the boiling point or more.

### EXAMPLES

An embodiment of the present invention will be described as an example by the following examples. The present invention is not limited by those examples.

The following compounds were used for the following examples:

Biphenyl (BP, a product with a purity of 99.5% manufactured by Tokyo Chemical Industry Co., Ltd.)
Diphenylene oxide (DPNO, a product with a purity of 97% manufactured by Tokyo Chemical Industry Co., Ltd.)
Naphthalene (NA, a product with a purity of 98% manufactured by Tokyo Chemical Industry Co., Ltd.)
Anthracene (AN, a product with a purity of 97% manufactured by Tokyo Chemical Industry Co., Ltd.)
o-Triphenyl (o-TER, a product with a purity of 99% manufactured by Tokyo Chemical Industry Co., Ltd.)
m-Triphenyl (m-TER, a product with a purity of 98% manufactured by Tokyo Chemical Industry Co., Ltd.)
p-Triphenyl (p-TER, a product with a purity of 99% manufactured by Tokyo Chemical Industry Co., Ltd.)
Phenanthrene (PH, a product with a purity of 98% manufactured by Sigma-Aldrich Corporation)
Diphenyl ether (DPO, a product with a purity of 99% manufactured by Tokyo Chemical Industry Co., Ltd.)
o-Hydroxyphenyl (OPP, a product with a purity of 99% manufactured by Wako Pure Chemical Industries, Ltd.)
1,1-Diphenyl ethane (DPE, manufactured by JX Nippon Oil & Energy Corporation)
Benzyl toluene isomers mixture (BT, a trial product containing 4% by mass of the o-isomer, 59% by mass of the m-isomer, and 37% by mass of the p-isomer)
Dibenzyl toluene (DBT, NeoSK-OIL 1400 manufactured by Soken Tecnix Co., Ltd.)
Phenyl xylyl ethane (PXE, manufactured by JX Nippon Oil & Energy Corporation)
3-Ethyl biphenyl (EBP, a product with a purity of 98% manufactured by Tokyo Chemical Industry Co., Ltd.)

### Example 1

Biphenyl, diphenylene oxide, naphthalene, anthracene, o-triphenyl, m-triphenyl, and p-triphenyl were blended in accordance with the respective ratios (% by mass) in Table 1 below to prepare a heating medium composition 1. A U-shaped pipe with an inner diameter of 14 mm, a width of 65 mm, and a height of 158 mm was filled with 20 g of the heating medium composition 1, the U-shaped pipe was charged with nitrogen, and the pressure therein was adjusted to be 2 MPa, then a heat stability test was performed at 430° C. for 96 hours. The appearance of the heating medium composition 1 at 25° C., 30° C., and 35° C. before the test was determined visually (◯: liquid, x: solid content is present), and gas chromatography mass analysis was performed on the heating medium composition 1 after the test to determine a decomposition ratio (%), the amount of decomposed phenol (%), and a pressure rise. The results are listed in Table 1.

### Example 2

Biphenyl, diphenylene oxide, naphthalene, and phenanthrene were blended in accordance with the respective ratios (% by mass) in Table 1 below to prepare a heating medium composition 2. The test was performed in the same manner as Example 1 except that the prepared heating medium composition 2 was used. The results are listed in Table 1.

### Example 3

Biphenyl, diphenylene oxide, and naphthalene were blended in accordance with the respective ratios (% by mass) in Table 1 below to prepare a heating medium composition 3. The same as Example 1 was performed except that the prepared heating medium composition 3 was used. The results are listed in Table 1.

### Example 4

Biphenyl, diphenylene oxide, naphthalene, and phenanthrene were blended in accordance with the respective ratios (% by mass) in Table 1 below to prepare a heating medium composition 4. The same as Example 1 was performed except that the prepared heating medium composition 4 was used. The results are listed in Table 1.

### Example 5

Biphenyl, diphenylene oxide, naphthalene, and phenanthrene were blended in accordance with the respective ratios (% by mass) in Table 1 below to prepare a heating medium composition 5. The same as Example 1 was performed except that the prepared heating medium composition 5 was used. The results are listed in Table 1.

### Example 6

Biphenyl, diphenylene oxide, naphthalene, phenanthrene, and diphenyl ether were blended in accordance with the respective ratios (% by mass) in Table 1 below to prepare a heating medium composition 6. The same as Example 1 was performed except that the prepared heating medium composition 6 was used. The results are listed in Table 1. Although having produced a minute amount of decomposed phenol (0.02%), the heating medium composition 6 containing 5% by mass of diphenyl ether showed sufficient heat stability.

### Example 7

Biphenyl, diphenylene oxide, anthracene, o-triphenyl, m-triphenyl, and phenanthrene were blended in accordance with the respective ratios (% by mass) in Table 1 below to prepare a heating medium composition 7. The same as Example 1 was performed except that the prepared heating medium composition 7 was used. The results are listed in Table 1.

### Comparative Example 1

Biphenyl and diphenyl ether were blended in accordance with one of the formulations disclosed in U.S. Pat. No. 1,882,809, that is, the respective ratios (% by mass) in Table 1 below to prepare a heating medium composition. The same as Example 1 was performed except that the prepared heating medium composition was used. The results are listed in Table 1. The decomposition ratio was 6.4%, which was lower in thermal stability than any of the examples, and decomposed phenol was produced in an amount of 0.34% by mass.

### Comparative Example 2

Biphenyl, o-triphenyl, m-triphenyl, and diphenyl ether were blended in accordance with one of the formulations disclosed in Japanese Patent Application Laid-open No. 01-261490, that is, the respective ratios (% by mass) in Table 1 below to prepare a heating medium composition. The same as Example 1 was performed except that the prepared heating medium composition was used. The results are listed in Table 1. The decomposition ratio was 5.3%, which was lower in thermal stability than any of the examples, and decomposed phenol was produced in an amount of 0.27% by mass.

### Comparative Example 3

Biphenyl, diphenylene oxide, and naphthalene were blended in accordance with the respective ratios (% by mass) in Table 1 below to prepare a heating medium composition. The same as Example 1 was performed except that the prepared heating medium composition was used. The results are listed in Table 1. It was confirmed that the heating medium composition of Comparative Example 3 whose ratio of biphenyl exceeded 50% by mass was not liquid at 30° C.

### Comparative Example 4

Biphenyl, diphenylene oxide, and naphthalene were blended in accordance with the respective ratios (% by mass) in Table 1 below to prepare a heating medium composition. The same as Example 1 was performed except that the prepared heating medium composition was used. The results are listed in Table 1. It was confirmed that the heating medium composition of Comparative Example 4 whose ratio of biphenyl exceeded 40% by mass was not liquid at 30° C.

### Comparative Example 5

Biphenyl, diphenylene oxide, naphthalene, and, phenanthrene were blended in accordance with the respective ratios (% by mass) in Table 1 below to prepare a heating medium composition. The same as Example 1 was performed except that the prepared heating medium composition was used. The results are listed in Table 1. It was confirmed that the heating medium composition of Comparative Example 5 whose total amount of aromatic compounds (C), that is, naphthalene and phenanthrene exceeded 75% by mass was not liquid at 30° C.

### Comparative Example 6

Biphenyl, phenanthrene, and o-hydroxyphenyl were blended in accordance with the respective ratios (% by mass) in Table 1 below to prepare a heating medium composition. The same as Example 1 was performed except that the prepared heating medium composition was used. The results are listed in Table 1. It was confirmed that its pressure rise after the thermal stability test was higher than that of any of the examples.

### Comparative Example 7

The same as Example 1 was performed except that 1,1-diphenyl ethane was used and that the test temperature was 400° C. The results are listed in Table 1. It was confirmed that its pressure rise after the thermal stability test was higher than that of any of the examples.

### Comparative Example 8

The same as Example 1 was performed except that a benzyl toluene isomers mixture obtained in a supplementary examination for the reference manufacture example disclosed in Japanese Patent Application Laid-open No. 01-200510 was used and that the test temperature was 400° C. The results are listed in Table 1. It was confirmed that its pressure rise after the thermal stability test was higher than that of any of the examples.

### Comparative Example 9

The same as Example 1 was performed except that dibenzyl toluene was used and that the test temperature was 400° C. The results are listed in Table 1. It was confirmed that its pressure rise after the thermal stability test was higher than that of any of the examples.

### Comparative Example 10

The same as Example 1 was performed except that phenyl xylyl ethane was used and that the test temperature was 380° C. The results are listed in Table 1. It was confirmed that its pressure rise after the thermal stability test was higher than that of any of the examples.

### Comparative Example 11

The same as Example 1 was performed except that 3-ethyl biphenyl was used and that the test temperature was 400° C. The results are listed in Table 1. It was confirmed that its pressure rise after the thermal stability test was higher than that of any of the examples.

### Comparative Example 12

Biphenyl and diphenyl ether were blended in accordance with one of the formulations disclosed in U.S. Pat. No. 1,882,809, that is, the respective ratios (% by mass) in Table 1 below to prepare a heating medium composition. The same as Example 1 was performed except that the prepared heating medium composition was used. The results are listed in Table 1. The decomposition ratio was 7.0%, which was lower in thermal stability than any of the examples, and decomposed phenol was produced in an amount of 0.37% by mass.

### Comparative Example 13

Biphenyl, diphenylene oxide, and diphenyl ether were blended in accordance with one of the formulations disclosed in Japanese Patent Application Laid-open No. 05-009465, that is, the respective ratios (% by mass) in Table 1 below to prepare a heating medium composition. The same as Example 1 was performed except that the prepared heating medium composition was used. The results are listed in Table 1. The decomposition ratio was 6.8%, which was lower in thermal stability than any of the examples, and decomposed phenol was produced in an amount of 0.33% by mass.

### Comparative Example 14

Biphenyl, o-triphenyl, m-triphenyl, and diphenyl ether were blended in accordance with one of the formulations disclosed in Japanese Patent Application Laid-open No. 01-261490, that is, the respective ratios (% by mass) in Table 1 below to prepare a heating medium composition. The same as Example 1 was performed except that the prepared heating medium composition was used. The results are listed in Table 1. The decomposition ratio was 3.9%, which was lower in thermal stability than any of the examples, and decomposed phenol was produced in an amount of 0.20% by mass.

### Comparative Example 15

Biphenyl and diphenylene oxide were blended in accordance with the respective ratios (% by mass) in Table 1 below to prepare a heating medium composition. The same as Example 1 was performed except that the prepared heating medium composition was used. The results are listed in Table 1. It was confirmed that the heating medium composition of Comparative Example 15 was not liquid at 30° C.

### Comparative Example 16

Diphenylene oxide, naphthalene, and phenanthrene were blended in accordance with the respective ratios (% by mass) in Table 1 below to prepare a heating medium composition. The same as Example 1 was performed except that the prepared heating medium composition was used. The results are listed in Table 1. It was confirmed that the heating medium composition of Comparative Example 16 was not liquid at 30° C.

TABLE 1

| | | | | | | | | | | | | | | | | Decom- | | | | | |
|---|---|---|---|---|---|---|---|---|---|---|---|---|---|---|---|---|---|---|---|---|---|
| | | | | | | | p- | | | | | | | | | position | Decomposed | Pressure | Appearance | | |
| | BP | DPNO | NA | AN | o-TER | m-TER | TER | PH | DPO | OPP | DPE | BT | DBT | PXE | EBP | rate | phenol | rise | 25° C. | 30° C. | 35° C. |
| Example 1 | 16.7% | 13.0% | 17.7% | 1.0% | 38.2% | 12.7% | 0.5% | | | | | | | | | 1.5% | 0.0% | 0.1 MPa | ◯ | ◯ | ◯ |
| | | | | | | | | | | | | | | | | | | or less | | | |
| Example 2 | 36.2% | 30.6% | 26.7% | | | | | 6.5% | | | | | | | | 2.7% | 0.0% | 0.1 MPa | ◯ | ◯ | ◯ |
| | | | | | | | | | | | | | | | | | | or less | | | |
| Example 3 | 41.5% | 29.8% | 28.7% | | | | | | | | | | | | | 2.6% | 0.0% | 0.1 MPa | X | ◯ | ◯ |
| | | | | | | | | | | | | | | | | | | or less | | | |
| Example 4 | 30.9% | 25.0% | 23.8% | | | | | 20.3% | | | | | | | | 2.5% | 0.0% | 0.1 MPa | ◯ | ◯ | ◯ |
| | | | | | | | | | | | | | | | | | | or less | | | |
| Example 5 | 27.7% | 22.2% | 29.0% | | | | | 21.1% | | | | | | | | 2.6% | 0.0% | 0.1 MPa | ◯ | ◯ | ◯ |
| | | | | | | | | | | | | | | | | | | or less | | | |
| Example 6 | 28.0% | 24.0% | 25.0% | | | | | 18.0% | 5.0% | | | | | | | 2.9% | 0.02% | 0.1 MPa | ◯ | ◯ | ◯ |
| | | | | | | | | | | | | | | | | | | or less | | | |
| Example 7 | 26.4% | 22.4% | | 0.5% | 40.6% | 4.9% | | 5.2% | | | | | | | | 1.2% | 0.00% | 0.1 MPa | ◯ | ◯ | ◯ |
| | | | | | | | | | | | | | | | | | | or less | | | |
| Comparative | 26.5% | | | | | | | | 73.5% | | | | | | | 6.4% | 0.34% | 0.1 MPa | ◯ | ◯ | ◯ |
| Example 1 | | | | | | | | | | | | | | | | | | or less | | | |
| Comparative | 25.0% | | | | 10.0% | 5.0% | | | 60.0% | | | | | | | 5.3% | 0.27% | 0.1 MPa | ◯ | ◯ | ◯ |
| Example 2 | | | | | | | | | | | | | | | | | | or less | | | |
| Comparative | 52.8% | 30.2% | 17.0% | | | | | | | | | | | | | 2.1% | — | 0.1 MPa | X | X | X |
| Example 3 | | | | | | | | | | | | | | | | | | or less | | | |
| Comparative | 40.0% | 43.0% | 17.0% | | | | | | | | | | | | | 2.7% | — | 0.1 MPa | X | X | X |
| Example 4 | | | | | | | | | | | | | | | | | | or less | | | |
| Comparative | 10.0% | 7.0% | 42.7% | | | | | 40.3% | | | | | | | | 2.8% | — | 0.1 MPa | X | X | X |
| Example 5 | | | | | | | | | | | | | | | | | | or less | | | |
| Comparative | 29.6% | | | | | | | 21.4% | | 49.0% | | | | | | — | — | 0.2 MPa | ◯ | ◯ | ◯ |
| Example 6 | | | | | | | | | | | | | | | | | | | | | |
| Comparative | | | | | | | | | | | 100.0% | | | | | — | — | 1.0 MPa | ◯ | ◯ | ◯ |
| Example 7 | | | | | | | | | | | | | | | | | | | | | |
| Comparative | | | | | | | | | | | | 100.0% | | | | — | — | 0.3 MPa | ◯ | ◯ | ◯ |
| Example 8 | | | | | | | | | | | | | | | | | | | | | |
| Comparative | | | | | | | | | | | | | 100.0% | | | — | — | 1.1 MPa | ◯ | ◯ | ◯ |
| Example 9 | | | | | | | | | | | | | | | | | | | | | |
| Comparative | | | | | | | | | | | | | | 100.0% | | — | — | 1.1 MPa | ◯ | ◯ | ◯ |
| Example 10 | | | | | | | | | | | | | | | | | | | | | |
| Comparative | | | | | | | | | | | | | | | 100.0% | — | — | 0.3 MPa | ◯ | ◯ | ◯ |
| Example 11 | | | | | | | | | | | | | | | | | | | | | |
| Comparative | 20.0% | | | | | | | | 80.0% | | | | | | | 7.0% | 0.37% | 0.1 MPa | ◯ | ◯ | ◯ |
| Example 12 | | | | | | | | | | | | | | | | | | or less | | | |
| Comparative | 18.0% | 10.0% | | | | | | | 72.0% | | | | | | | 6.8% | 0.33% | 0.1 MPa | ◯ | ◯ | ◯ |
| Example 13 | | | | | | | | | | | | | | | | | | or less | | | |
| Comparative | 15.9% | | | | 30.0% | 10.0% | | | 44.1% | | | | | | | 3.9% | 0.20% | 0.1 MPa | ◯ | ◯ | ◯ |
| Example 14 | | | | | | | | | | | | | | | | | | or less | | | |
| Comparative | 26.5% | 73.5% | | | | | | | | | | | | | | 3.4% | 0.00% | 0.1 MPa | X | X | X |
| Example 15 | | | | | | | | | | | | | | | | | | or less | | | |
| Comparative | | 47.7% | 24.2% | | | | | 28.1% | | | | | | | | 3.7% | 0.00% | 0.1 MPa | X | X | X |
| Example 16 | | | | | | | | | | | | | | | | | | or less | | | |

### INDUSTRIAL APPLICABILITY

The heating medium composition according to the present invention is suitable for heat removal in high-temperature exothermic reactions, heat reservoirs, and solar thermal power generation because it can be used continuously at higher temperatures. The use of the heating medium composition according to the present invention in the above field can achieve a longer life, improve power generation efficiency, and reduce running costs.

1. A heating medium composition comprising at least biphenyl (A) and diphenylene oxide (B), further comprising
at least one or more aromatic compounds (C) selected from six components of naphthalene, phenanthrene, anthracene, o-triphenyl, m-triphenyl, and p-triphenyl, wherein
the biphenyl (A) is contained in a ratio of 15 to 50% by mass, the diphenylene oxide (B) is contained in a ratio of 10 to 40% by mass, the aromatic compounds (C) is contained in a ratio of 20 to 75% by mass, and diphenyl ether is not contained.

2. The heating medium composition according to claim 1, wherein the biphenyl (A) is contained in a ratio of 15 to 40% by mass, the diphenylene oxide (B) is contained in a ratio of 10 to 40% by mass, and the aromatic compounds (C) is contained in a ratio of 20 to 75% by mass.

3. The heating medium composition according to claim 1, wherein the biphenyl (A) is contained in a ratio of 20 to 40% by mass, the diphenylene oxide (B) is contained in a ratio of 10 to 40% by mass, and an aromatic compound (C) selected from naphthalene and/or phenanthrene is contained in a ratio of 20 to 70% by mass.

4. The heating medium composition according to claim 1 for use in solar thermal power generation.

5. The heating medium composition according to claim 2 for use in solar thermal power generation.

6. The heating medium composition according to claim 3 for use in solar thermal power generation.
